(19) United States
(12) Patent Application Publication
(10) Pub. No.: US 2005/0143883 A1
(43) Pub. Date: Jun. 30, 2005

(54) Vehicle management system

(75) Inventor: Toshio Yamagiwa, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/016,469

(22) Filed: Dec. 17, 2004

(30) Foreign Application Priority Data
Dec. 24, 2003 (JP) 2003-428133

(51) Int. Cl. G05B 23/00

(52) U.S. Cl. 701/32; 340/10.1

(57) ABSTRACT

A vehicle management system in which, for all events and transactions relating to a vehicle, from production of the vehicle to disposal thereof, information is inputted from IC tags fixed to parts constituting a vehicle and stored, while a vehicle body ID marked on a body of the vehicle is also inputted and stored. Thus, the vehicle is identified on the basis of the information inputted from IC tags, and the vehicle body ID is identified by the registration or history information of the vehicle. The system then checks the identified vehicle body ID and the inputted vehicle body ID against each other, and the registration or history information of the vehicle is managed on the basis of the result of the checking. The vehicle management system improves the reliability of registration and/or history information of a vehicle during a period from production to disposal of the vehicle.

### CROSS-REFERENCE TO RELATED APPLICATIONS

The present invention claims priority under 35 USC 119 based on Japanese patent application No. 2003-428133, filed on Dec. 24, 2003. The subject matter of the priority document is incorporated by reference herein.

### BACKGROUND OF THE INVENTION

1. Field of the Invention

The present invention relates to a vehicle management system for managing the registration and/or history information of a vehicle during a period from production of the vehicle to disposal of the vehicle.

2. Description of the Background Art

Management of articles by use of a method in which secret or private identification information is communicated wirelessly has gradually become widespread. The communication method is called RFID (Radio Frequency IDentification), and can be used for managing, for instance, location and kind of products stocked by use of computers. In order to manage an article, an RFID tag (also called an IC tag, a radio tag, an electronic tag and the like) is attached onto the article or its package. The tag is small in size and has an IC (Integrated Circuit) and means for transmitting and receiving radio signal embedded therein. Information for identifying product classification and individual product in a distribution process of the article or the like can be read out from the IC tag.

In addition, in Japanese Patent Laid-Open No. 2003-170872, there is disclosed a checking apparatus for checking stolen vehicles by securing IC tags to vehicles. According to this invention, IC tags, which wirelessly output unique registration numbers for respective bicycles, are attached to the bicycles, and a list of stolen vehicles showing the registration numbers of the stolen bicycles is stored in a database. A portable wireless terminal acquires a registration number from the IC tag attached to the bicycle and checks the list of stolen vehicles on the database. The result of the checking is received by the source portable wireless terminal and displayed thereon. Accordingly, since the checking of vehicles can be performed efficiently, the cost of antitheft measures is reduced.

However, in the above described background apparatus, it has been impossible to identify things other than the part provided with the IC tag. For example, in vehicles provided with an IC tag on the body thereof, it has been impossible to identify replacement of a vehicle part, such as an engine assembly.

The present invention is made in consideration of such a circumstance. An object of the present invention is to provide a vehicle management system which previously stores an identifier (ID) of individual parts in the system, which constitute the vehicle and are expected to be changed, and wherein the vehicle management system is capable of identifying the modification of the vehicle by checking IDs as needed.

### SUMMARY OF THE INVENTION

This invention is made to solve the above described deficiencies of the background art. According to one aspect of the present invention, there is provided a vehicle management system for managing a plurality of vehicles, wherein each vehicle comprises a vehicle body and a plurality of parts. The vehicle management system comprises: a vehicle body identifier (ID) marked on the vehicle body, and integrated circuit (IC) tags attached to at least some of the plurality of parts, of each of the vehicles; the IC tags storing the vehicle body ID and the respective part IDs of the plurality of parts; storage means for also storing the vehicle body ID and the part IDs, the part IDs being associated with the vehicle body ID; and identification means for identifying the vehicle by the vehicle body ID and the part IDs stored in the storage means, as well as by the vehicle body ID and a plurality of part IDs read out from the IC tags of the vehicle.

According to such a configuration, coincidence, consistency and/or conformity of the vehicle data is checked by the vehicle body ID and the part IDs stored in external storage means as well as the vehicle body ID and a plurality of part IDs read out from IC tags of the vehicle.

In addition, according to another aspect of the present invention, the vehicle management system further comprises registration means for registering registration and/or history information of the vehicle. According to such a configuration, the registration and/or history information of the vehicle is registered in the external storage means.

In addition, according to another aspect of the present invention, the IC tags storing the vehicle ID are storage means into which registration or history information of the vehicle can be written. According to such a configuration, it is possible to rewrite and/or add to the registration or history information of the vehicle stored in the IC tags.

In addition, according to another aspect of the present invention, one of the IC tags of each vehicle storing the vehicle ID is attached to a meter of the vehicle, and the other IC tags of the vehicle, for example, those that are secured to parts which constitute the vehicle, are read-only storage means for storing only the respective part IDs. According to such a configuration, the rewriting of the part IDs is prevented.

As described above, according to the present invention, coincidence, consistency and/or conformity of the vehicle data is checked by using the vehicle body ID and the part IDs stored in the external storage means as well as the vehicle body ID and a plurality of part IDs read out from IC tags of the vehicle. Thus, the reliability of identification of a vehicle can be improved by recognizing a vehicle at two or more places.

In addition, according to the present invention, the registration or history information of the vehicle is registered in the external storage means. Thus, the reliability of registration, or production and selling history, can be further improved by recognizing a vehicle at two or more places, i.e. the information which is managed together with the vehicle and the information which is managed separately from the vehicle, and by identifying the registration and/or production and selling history of the vehicle.

In addition, according to another aspect of the present invention, the registration or history information of the vehicle can be rewritten and/or added in the IC tags storing the vehicle body ID. Accordingly, it is possible to manage the registration or history information and the vehicle body ID with the registration or history information associated with the vehicle body ID.

In addition, according to the present invention, the rewriting of the part IDs is prevented. Accordingly, it is possible to prevent false recognition of a vehicle caused by the rewriting of the part IDs.

Modes for carrying out the present invention are explained below by reference to an embodiment of the present invention shown in the attached drawings. The above-mentioned object, other objects, characteristics and advantages of the present invention will become apparent form the detailed description of the embodiment of the invention presented below in conjunction with the attached drawings.

### BRIEF DESCRIPTION OF THE DRAWINGS

FIG. 1 is a schematic configuration diagram of a vehicle management system according to one embodiment of this invention, showing a plurality of user terminals linked to a vehicle information management server through a communication network.

FIG. 2 is a schematic diagram of a vehicle registration certificate, showing an IC tag embedded thereon.

FIG. 3 is a data structure chart stored in a memory in an IC tag, showing rewrite inhibited areas as well as rewritable areas.

FIG. 4 is a data structure diagram of owner data included in the vehicle information database.

FIG. 5 is a flowchart showing a vehicle management process for a single event.

FIG. 6 is a data structure diagram of part configuration data included in the vehicle information database.

FIG. 7 is a data structure diagram of vehicle history data included in the vehicle information database.

FIG. 8 is a data structure diagram of waste manifest issuance data included in the vehicle information database.

FIG. 9 is a schematic diagram showing a list of functions of the control unit of the vehicle information management server.

FIG. 10 is a schematic diagram showing processing and data flow in the disposal/recycle system function of the control unit of the vehicle information management server.

### DETAILED DESCRIPTION OF THE INVENTION

With reference to the drawings, an embodiment of a vehicle of the present invention will be described below.

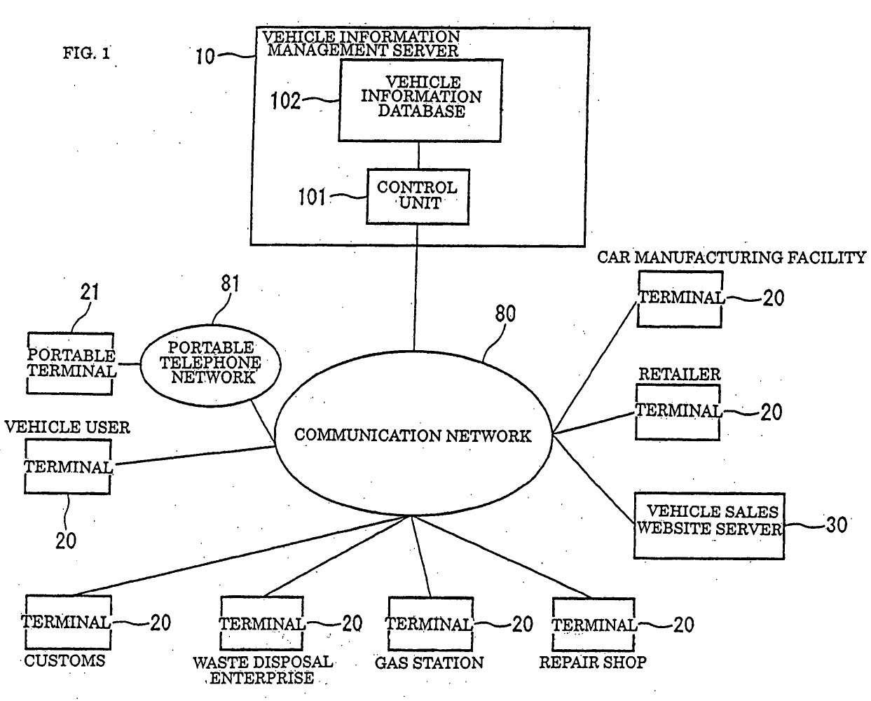

FIG. 1 is a block diagram showing a configuration of a vehicle management system according to the embodiment. In FIG. 1, reference numeral 10 denotes a vehicle information management server. The vehicle information management server 10 shown therein includes a control unit 101 and a vehicle information database 102. The control unit 101 includes input means, vehicle body ID identification means, and information management means. The vehicle information database 102 includes vehicle information storage means. Moreover, in FIG. 1, reference numerals 20 denote remote terminals. The remote terminals are provided, respectively, in a vehicle manufacturing facility, a vehicle retailer, a vehicle repair shop, a gas station, a vehicle waste disposal enterprise, customs, a vehicle user's house and the like. Note that, according to need, an IC tag reader/writer (tag information read and write means) is connected to each of the terminals 20. Thus, it is made possible to read and write information in a memory in an IC tag provided in a vehicle or in an IC tag embedded in a vehicle registration certificate. Note that the waste disposal enterprise includes: a discharging enterprise which discharges wastes; a collector/transporter which collects/transports discharged wastes; an intermediate treatment enterprise which performs intermediate treatment of wastes; a final disposal enterprise which performs final disposal after the intermediate treatment; and the like. The system provides a portable terminal 21 which is carried by a vehicle user, for example. Moreover, a server 30 of a vehicle sales website, provided for selling vehicles by use of a so-called web interface via a communication network, is also included in the system.

The vehicle management system includes a communication network 80, through which the vehicle information management server 10, the terminals 20, the portable terminal 21 and the vehicle sales website server 30 can communicate with each other. Note that the portable terminal 21 can be connected to the communication network 80 via a portable telephone network 81. Here, the portable telephone network 81 and the communication network 80 are connected to each other via a gateway device and the like (not shown).

In the vehicle information management server 10, the vehicle information database 102 retains management information related to each vehicle throughout its entire life cycle from a stage of shipping the vehicle from a factory to a stage of subjecting the vehicle to waste disposal. Moreover, as described later, the control unit 101 refers to data stored in the vehicle information database 102 and writes data into the vehicle information database 102 while exchanging data with the terminals 20, the portable terminal 21, the vehicle sales website server 30 and the like.

Note that the vehicle information management server 10, the terminals 20 and the vehicle sales website server 30 are realized by use of a computer. The portable terminal 21 is a device selected from the group including, but not limited to, a portable telephone terminal such as a mobile telephone terminal or a Personal Handyphone System ((PHS), registered trademark) terminal, or a Personal Digital Assistant (PDA), or the like. Each of the devices described above includes a central processing unit (CPU) therein. Here, stages of processing performed by the respective devices are stored in a computer-readable recording medium in a form of a computer program. Accordingly, this program is read out and executed by the CPU and the foregoing processing is performed. Here, the computer-readable recording medium means a magnetic disk, a magneto-optical disk, a CD-ROM, a DVD-ROM, a semiconductor memory or the like. Moreover, this computer program may be delivered to a computer through a communication line, and a CPU provided in the computer which has received this delivery may execute the program.

Next, description will be given of means for identifying vehicles individually in the system of the present invention. A vehicle is marked with a vehicle body ID, and IC tags are fixed to parts constituting the vehicle during a period from production to disposal of the vehicle. This IC tag stores the vehicle ID in a semiconductor memory embedded therein. In this semiconductor memory, both a rewrite-inhibited area and a rewritable area exist. In the rewrite-inhibited area, at least a vehicle ID for identifying a vehicle is previously written.

Vehicles which may be managed using the inventive vehicle management system include, but are not limited to, a motorcycle, a four-wheeled vehicle, a bicycle, a personal water craft (PWC) and a four-wheel buggy. With regard to the attachment position of the IC tag 72 on the vehicle, it is possible to provide the IC tag in a seat, for example, of a vehicle. Since the seat is made of a resin member through which electromagnetic waves are transmitted, it is advantageous to attach the IC tag to the inside of the seat as described above in order to read and write the stored information of the IC tag by use of electromagnetic wave signals. Moreover, although the IC tag is fixed to the vehicle during the period from production to disposal of the vehicle, by providing the IC tag in the seat, there is an advantage that the IC tag is not easily detached therefrom.

Note that, in the case of a vehicle having a metal roof, such as a passenger car, a bus and a truck, the IC tag is attached to the inside of the seat and a handheld reader/writer is carried into the vehicle, and thus, information of the IC tag is read out and written. Alternatively, the IC tag may be attached to the vicinity of a front window or a rear window of the passenger car. For example, the IC tag may be attached to a dashboard portion and the IC tag may be read out and written from above outside of the vehicle. Moreover, the IC tag may also be attached into, or formed within, a resin member which forms the dashboard portion.

In vehicles which use a saddle-type seat, typically these vehicles have no metal roof or the like covering an upper side of the seat. Thus, it is possible to place the IC tag reader/writer above a vehicle stopping position or the like at a gas station, at a repair shop, in the road and the like, which is advantageous for ease of data transfer.

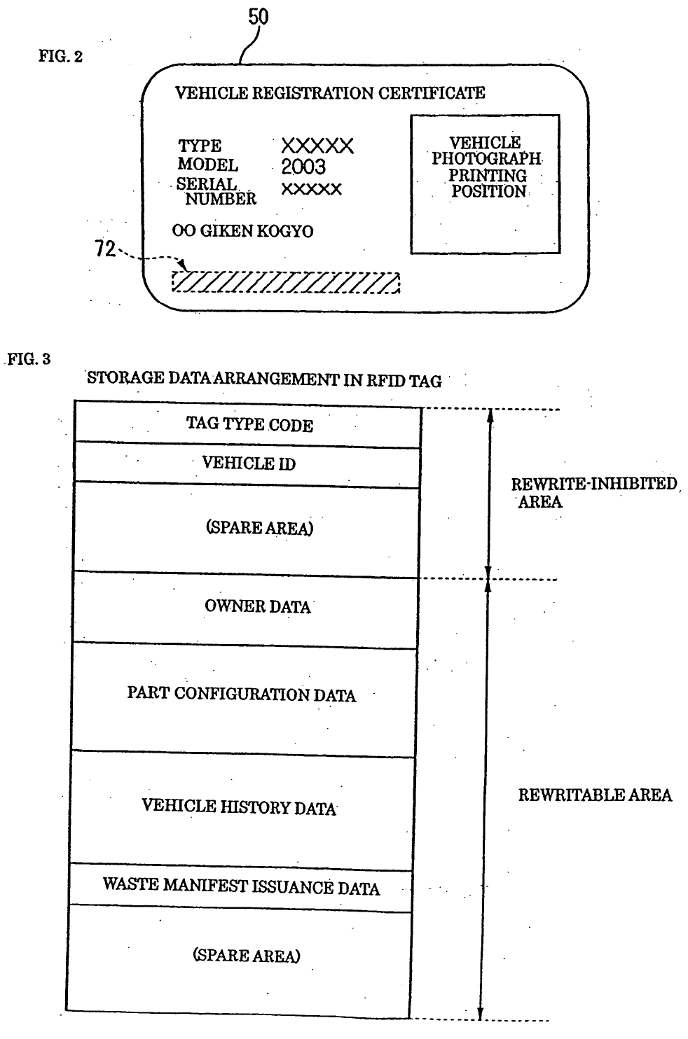

Next, description will be given of a vehicle registration certificate (an ID card) used in the system of the present invention. FIG. 2 is a schematic diagram showing one example of a face of the vehicle registration certificate. In FIG. 2, the vehicle registration certificate 50 is a certificate issued for each vehicle. As shown in FIG. 2, on a surface thereof, a type, a model year (indicated as “MODEL 2003”), a serial number, and a manufacturer's name of a target vehicle are listed. Moreover, a photograph of the vehicle is printed on or attached to the surface of the certificate. Moreover, reference numeral 72 denotes an IC tag embedded in the vehicle registration certificate 50. A semiconductor memory is embedded in the IC tag 72. In the semiconductor memory, both a rewrite-inhibited area and a rewritable area exist.

In the case where the vehicle registration certificate is used for checking against an IC tag fixed to a part, instead of a vehicle body ID marked on the vehicle body, information corresponding to the IC tag fixed to the part is written with a corresponding stated time, such as the time of issuance or selling.

Note that it is assumed that the vehicle registration certificate described above is issued by a manufacturer of the vehicle, a public organization which manages vehicle registration, or the like. Moreover, this vehicle registration certificate has a size of about a 5.3 cm×8.5 cm credit card, for example, and a material thereof is plastic or the like.

Next, description will be given of the information retained by the IC tags provided in the vehicle and the IC tag 72 embedded in the vehicle registration certificate 50. FIG. 3 is a schematic chart showing the structure of the data stored in a memory in the IC tags described above. As shown in FIG. 3, in the memory, a rewrite-inhibited area and a rewritable area exist. Rewrite is inhibited in the rewrite-inhibited area by using a ROM (Read Only Memory), for example. Alternatively, the rewrite-inhibited area can be controlled so as not to be rewritten by a control function included in the IC tag.

In the rewrite-inhibited area, an IC tag type code and a vehicle ID are stored, and a spare area is also provided. The IC tag type code is code information for discriminating whether the IC tag is an IC tag provided in a vehicle or an IC tag provided in a vehicle registration certificate. The vehicle ID is code information for identifying vehicles individually.

Moreover, in the rewritable area, owner data, part configuration data, vehicle history data, and waste manifest issuance data are stored, and a spare area is further provided. As to the owner data, part configuration data, vehicle history data, and waste manifest issuance data, similar pieces of information are retained and managed also in the vehicle information database 102, which is storage means of the vehicle management system, as described later.

In the system of the present invention, the vehicle management server 10 and the terminals 20 can communicate with each other through the communication network 80 (registration means constituted by these three parties). Thus, according to need, data stored in the vehicle information database 102 (owner data, part configuration data, vehicle history data, and waste manifest issuance data) and data stored in the IC tag (owner data, part configuration data, vehicle history data, and waste manifest issuance data) are appropriately updated in synchronization with each other. Moreover, since a storage capacity of the IC tag is limited, the vehicle information database 102 may have a full set of the respective data described above and the IC tag may have only a subset of the respective data. It is preferable that a random access memory be used for the IC tag storing the vehicle body ID and the IC tag be provided in the meter or seat described above. Particularly, this is effective in a motorcycle meter since motorcycle meters are not often replaced.

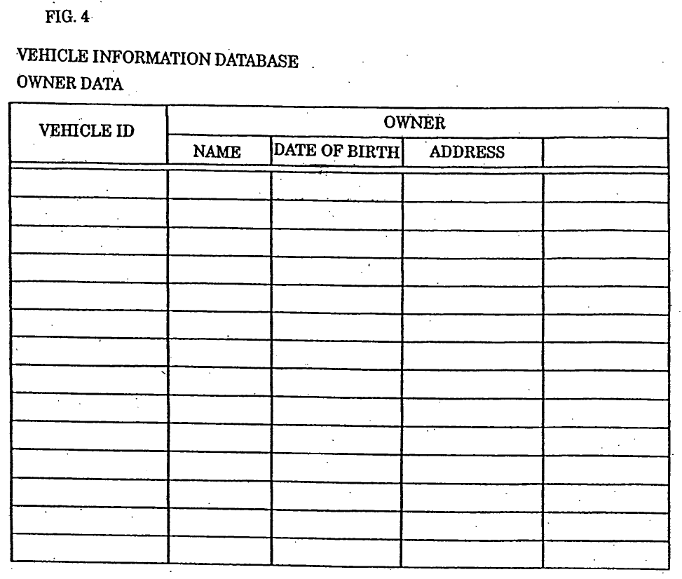

Next, with reference to FIGS. 4 to 8, description will be given of the respective data retained by the vehicle information database 102 and a vehicle management process flow. Note that data shown in the drawings are also partially or entirely retained by the IC tag side for each vehicle.

FIG. 4 is a schematic drawing showing a data structure of owner data included in the vehicle information database. As shown in FIG. 4, the owner data includes owner information associated with a vehicle ID. The owner information includes information such as, but not limited to, a name, a date of birth and an address of an owner.

In one use of the owner information, it is checked whether the owner of the vehicle of interest and the owner associated with the registration or history information on the vehicle information database 102 coincide with each other.

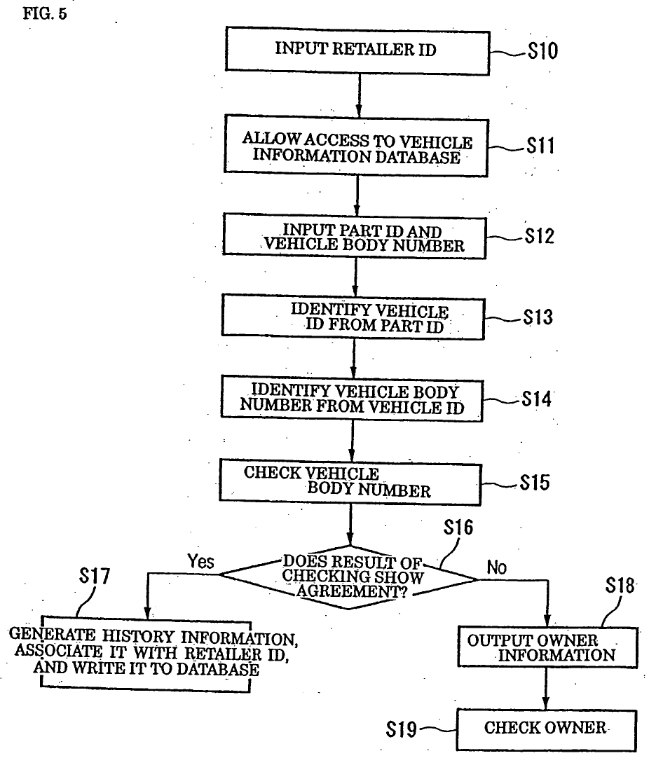

The vehicle management process for a single event will now be described with respect to FIG. 5.

In a terminal 20 in a retailer, when part IDs, stored respectively in a plurality of IC tags 72 fixed respectively to a plurality of parts constituting the vehicle of interest during the period from production to disposal of the vehicle, are inputted while a vehicle body ID marked on the body of the vehicle of interest is inputted (Step S12 of FIG. 5), the plurality of part IDs inputted from the IC tags 72 and the vehicle body ID marked on the vehicle body are transmitted to the vehicle information management server 10 through the communication network 80. It should be noted that, when a single IC tag among the plurality of IC tags includes the rewritable area and each of the other IC tags is made up of a ROM storing only the respective part IDs, it is made possible to inhibit the rewriting of part IDs.

When receiving the plurality of part IDs inputted from the IC tags 72 and the vehicle body ID marked on the vehicle body, the vehicle information management server 10 identifies the vehicle on the basis of the respective plurality of part IDs inputted from the IC tags 72 (Step S13), and manages the registration or history information of the vehicle associated with this identification information by use of the vehicle information database 102. Specifically, the vehicle body ID identified on the basis of the plurality of part IDs and the vehicle body ID marked on the vehicle body are checked against each other (Step S15), and the registration or history information of the vehicle during the period from production to disposal of the vehicle is managed on the basis of the result of the checking.

For example, if the result of the checking shows a disagreement (‘No’ in Step S16), the vehicle information management server 10 extracts the owner information indicating the owner of the vehicle of interest from the registration or history information of the vehicle associated with the identification information of the vehicle by use of the vehicle information database 102 (Step S18), and transmits the owner information to the terminal 20 of the retailer to check the owner (Step S19), or performs a process of checking the history of replacement of the parts.

Accordingly, the checking of the owner can be performed on the retailer side.

On the other hand, if the result of the checking shows an agreement (‘Yes’ in Step S16), the vehicle information management server 10 checks that the irregular replacement or the like has not been carried out, and transmits the certification result to the terminal 20 of the retailer.

Accordingly, for example, when selling used cars and recycling parts, more reliable information can be provided.

IC tags using inexpensive ROMs are preferably provided, for example, for engine parts or for various parts, such as wheels, swing arms, body frames, cushions, and units, which are expected to be replaced.

In addition, as an example of a modification of this embodiment, it is possible to input information from the vehicle registration certificate 50 into which the information corresponding to the IC tags 72 fixed to parts is written, instead of inputting the vehicle body ID marked on the vehicle body. That is, the vehicle information management server 10 checks the information inputted from the IC tag 72 on the vehicle registration certificate 50 against the information inputted from IC tags 72 fixed to parts by use of the vehicle information database 102, and thus manages the registration or history information of the vehicle during the period from production to disposal of the vehicle on the basis of the result of the checking.

Particularly in the IC tag 72 on the vehicle registration certificate 50, a retailer ID is written into it in addition to the identification information of the vehicle at the time of issuance of the vehicle registration certificate, so that the retailer ID is added to the history information for the checking (Step S17). Note that this retailer ID is also similarly added to the disposal time history to be described later.

Thus, in the case when the retailer ID is not added to the information inputted from the IC tag 72 on the vehicle registration certificate 50, the vehicle information management server 10 judges it to be an unauthorized access to the vehicle information database 102, and denies the access to the database. On the other hand, if the retailer ID is added to the information (Step S10), the server 10 judges it to be an access by the authorized person, and allows the access to the database (Step S11).

In this way, it is possible to restrict the access to the vehicle information management server 10 to improve the information security against the unauthorized access.

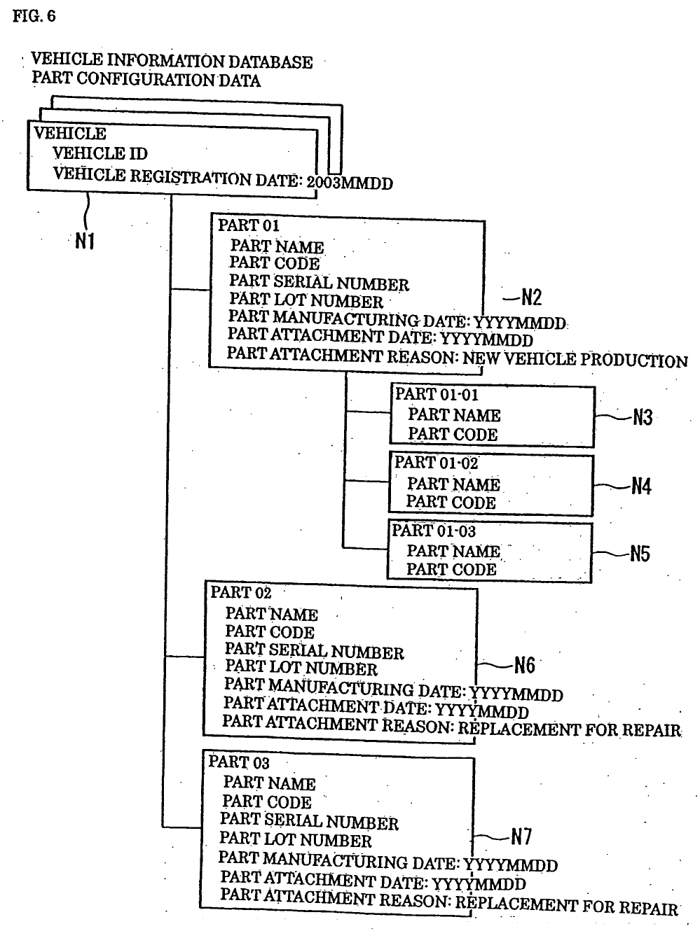

FIG. 6 is a schematic diagram showing a data structure of part configuration data included in the vehicle information database. As shown in the example of FIG. 6, the part configuration data retains information related to a part configuration for each vehicle (for each vehicle ID) as tree structure data. Reference codes N1 to N7 are nodes in this tree structure. The node N1 corresponds to a vehicle and includes data items such as a vehicle ID and a vehicle registration date. This vehicle is constituted of a part 01, a part 02, a part 03, and so on. Information related to these parts are stored in the nodes N2, N6 and N7, respectively. Moreover, the part data configuration is hierarchical. For example, the part 01 is further constituted of a sub-part 01-01, a part 01-02, a part 01-03, . . . and information related to these sub-parts is stored in the nodes N3 to N5, respectively.

Each of the nodes N2 to N7 includes data items such as a part name indicating a name of a part, a part code for identifying a type of a part, a part serial number allocated for each individual part, a part lot number indicating a lot when a part is manufactured, a part manufacturing date indicating a date when a part is manufactured, a part attachment date indicating a date when a part is attached to a vehicle or a date when a part is attached to a high-order part, and a part attachment reason indicating a reason for attaching a part (events, for example, “new vehicle production,” “replacement for repair” and the like).

Note that FIG. 6 exemplifies the case where the number of part hierarchies is two. However, there may be any number of hierarchies.

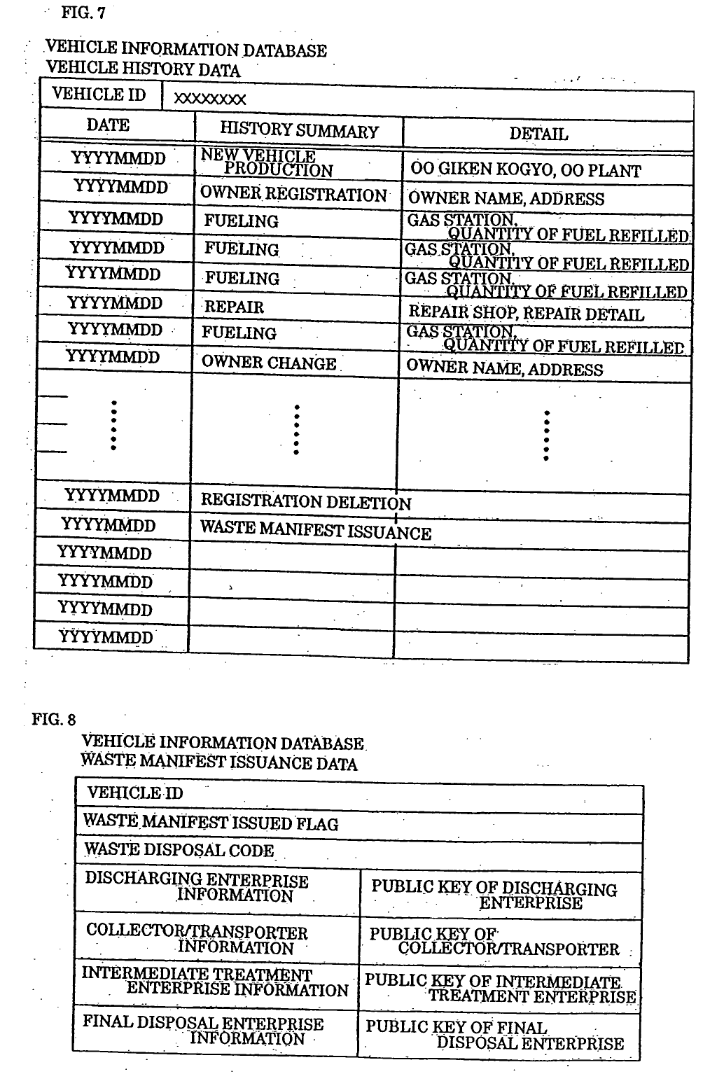

FIG. 7 is a schematic diagram showing a data structure of vehicle history data included in the vehicle information database. As shown in the example of FIG. 7, the vehicle history data retains history information for each vehicle (for each vehicle ID) and includes at least data items of a date, a history summary, and a detail. Values of the history summary items are, for example, “new vehicle production,” “owner registration,” “owner change,” “fueling,” “repair,” “registration deletion,” “waste manifest issuance” and the like. The history information described above is produced in the terminal 20 every time when the respective events occur. The information is written into the IC tag provided in the vehicle or the IC tag on the vehicle registration certificate according to need, and is transmitted to the control unit 101 from the terminal 20. The control unit 101 writes information into the database on the basis of the transmitted information.

Note that, when the history summary is specified as “new vehicle production,” a manufacturer name and a factory name is written as detailed data. When the history summary is specified as “owner registration,” an owner name, an owner address and the like are written as detailed data. When the history summary is specified as “fueling,” information specifying a gas station, information on a quantity of fuel refilled and an odometer at the time of fueling and the like are written as detailed data. When the history summary is specified as “repair,” information on a repair shop name and repair detail and the like are written as detailed data. When the history summary is specified as “owner change,” a name of a new owner, an address of the new owner and the like are written as detailed data.

FIG. 8 schematically shows waste manifest issuance data included in the vehicle information database. As shown in the example of FIG. 8, the waste manifest issuance data includes, for each vehicle (for each vehicle ID), data items such as a waste manifest issued flag, a waste disposal code, discharging enterprise information, collector/transporter information, intermediate treatment enterprise information, final disposal enterprise information, a public key of the discharging enterprise, a public key of the collector/transporter, a public key of the intermediate treatment enterprise and a public key of the final disposal enterprise. The waste manifest issued flag is information indicating whether or not a waste manifest is already issued. The waste disposal code is information indicating whether the waste manifest is issued in a form of paper or in an electronic form. Note that a secret key corresponding to each of the public keys is retained by a computer of each enterprise. Moreover, the enterprise at each stage (for example, the intermediate treatment enterprise) may be a plurality of enterprises in accordance with contents of the treatment. In this case, public key information for each enterprise is retained in the waste manifest issuance data.

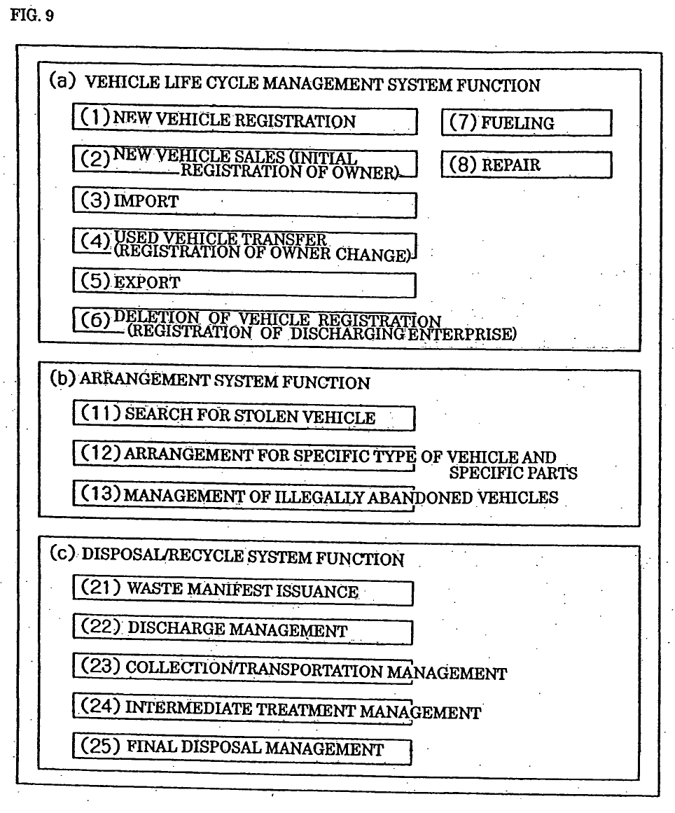

FIG. 9 is a schematic diagram showing a list of functions included in the control unit 101 of the vehicle information management server 10. As shown in FIG. 9, in this embodiment, the functions of the control unit 101 are broadly classified into (a) a vehicle life cycle management system function, (b) an arrangement system function and (c) a disposal/recycle system function.

To be more specific, the vehicle life cycle management system function includes functions such as (1) new vehicle registration, (2) new vehicle sales (initial registration of owner), (3) import, (4) used vehicle transfer (registration of owner change), (5) export, (6) deletion of vehicle registration information (registration of discharging enterprise), (7) fueling, and (8) repair. Moreover, the arrangement system function includes functions such as (11) search for a stolen vehicle, (12) arrangement for a specific type of vehicle and specific parts, and (13) management of illegally abandoned vehicles. Moreover, the disposal/recycle system function includes functions such as (21) waste manifest issuance, (22) discharge management, (23) collection/transportation management, (24) intermediate treatment management, and (25) final disposal management. Hereinafter, general description of each of the functions will be given.

(1) The new vehicle registration function receives a vehicle ID of a new vehicle, part configuration data thereof and the like from the terminal 20 of a vehicle manufacturing facility or the like, and registers data of the new vehicle in the vehicle information database 102. In this event, information to be written into an IC tag provided in a vehicle, an IC tag 72 embedded in a vehicle registration certificate or the like is simultaneously produced.

(2) The new vehicle sales (initial registration of owner) function receives data such as name and address of an owner from the terminal 20 of a retailer, a vehicle sales website server 30 or the like and registers owner data of the vehicle information database 102.

(3) The import function performs processing similar to that of the used vehicle transfer to be described later in the case of import from a country (region) to be managed according to the vehicle management system. In the case of import from the other countries (regions), owner data and part configuration data are registered as those of a new vehicle and past history information is registered as vehicle history data. Functions required for the processing of the import function are received from the terminal 20 of customs, for example.

(4) The used vehicle transfer (registration of owner change) function receives data such as name and address of an owner after transfer from the terminal 20 of a used vehicle retailer or the like, registers data of the new owner and adds vehicle history data in the vehicle information database 102.

(5) The export function performs processing similar to that of the above-described used vehicle transfer in the case of export to a country (region) to be managed according to the vehicle management system. In the case of export to the other countries (regions), owner data is updated or deleted and export records are added as vehicle history data. Functions required for the processing of the export function are received from the terminal 20 of customs, for example.

(6) The vehicle registration information deletion (registration of discharging enterprise) function adds information indicating registration deletion as vehicle history data, and performs processing of registering a discharging enterprise that is a first agent who contracts for waste disposal in the vehicle information database 102.

(7) The fueling function receives data related to fueling (fueling amount information, odometer information, gas station information and the like) from the terminal 20 of the gas station and performs processing of registering the received data as vehicle history data.

(8) The repair function receives data related to repair from the terminal 20 of a repair shop and registers the received data as vehicle history data. Moreover, when replacement of parts and the like are performed in the repair, the part configuration data in the vehicle information database is also updated.

(11) The stolen vehicle search function performs search of a theft by use of a vehicle ID of interest in the case of a stolen vehicle or the like. Information on the search of a theft is transmitted to the terminals 20 of customs, repair shops, gas stations or the like. For example, the vehicle management system is adapted such that, in a gas station, at a position where the vehicle stops for fueling, a vehicle ID is read out from an IC tag provided in a vehicle, so that the vehicle ID read out from the IC tag of the vehicle can be compared to a vehicle ID in the information on the search of a theft. Moreover, when the both IDs coincide with each other as a result of the comparison, the fueling may be automatically cut off and information on a location of the gas station may be notified to the vehicle information management server side. Thus, it is possible to easily determine the whereabouts of the stolen vehicle.

(12) In the case where life of a part of a specific lot is about to end or the like, for example, the specific vehicle-type/specific-part arrangement function specifies a vehicle having the part by searching the part configuration data in the vehicle information database 102, and obtains the owner data of the vehicle. Thus, it is possible to send guidance regarding part replacement and the like to the owner. Moreover, in part of the vehicle history data, a history of receiving automobile inspections, a history of replacing parts such as tires, a history of performing maintenance and inspections and the like may be included, so that, on the basis of the vehicle history data described above, when a predetermined period of time has passed since the last automobile inspection, part replacement, part inspection or the like, it is possible to send guidance of next automobile inspection, part replacement, inspection or the like, to the owner. The guidance described above may be mailed to the address of the owner or may be sent by e-mail to an e-mail address which is retained as the owner data. Moreover, in addition to the case of the life of the part, in a part having built-in control means by software, for example, guidance may be sent to the owner regarding function addition, or software updates, and the like for the software.

(13) The illegally abandoned vehicle management function outputs information related to an illegally abandoned vehicle. For example, when an illegally abandoned vehicle is found, a vehicle ID is read out from an IC tag provided in the vehicle by use of a hand-held terminal device or the like (portable terminal device) at the scene of abandonment. Thereafter, on the basis of this vehicle ID, the control unit 101 read outs vehicle history data and owner data of the relevant vehicle from the vehicle information database 102. Moreover, if the registration of the vehicle has already been deleted and the vehicle has already been subjected to waste disposal, the illegally abandoned vehicle management function tracks the status of waste disposal on the basis of the data written in the vehicle information database 102 by the disposal/recycle system function to be described later.

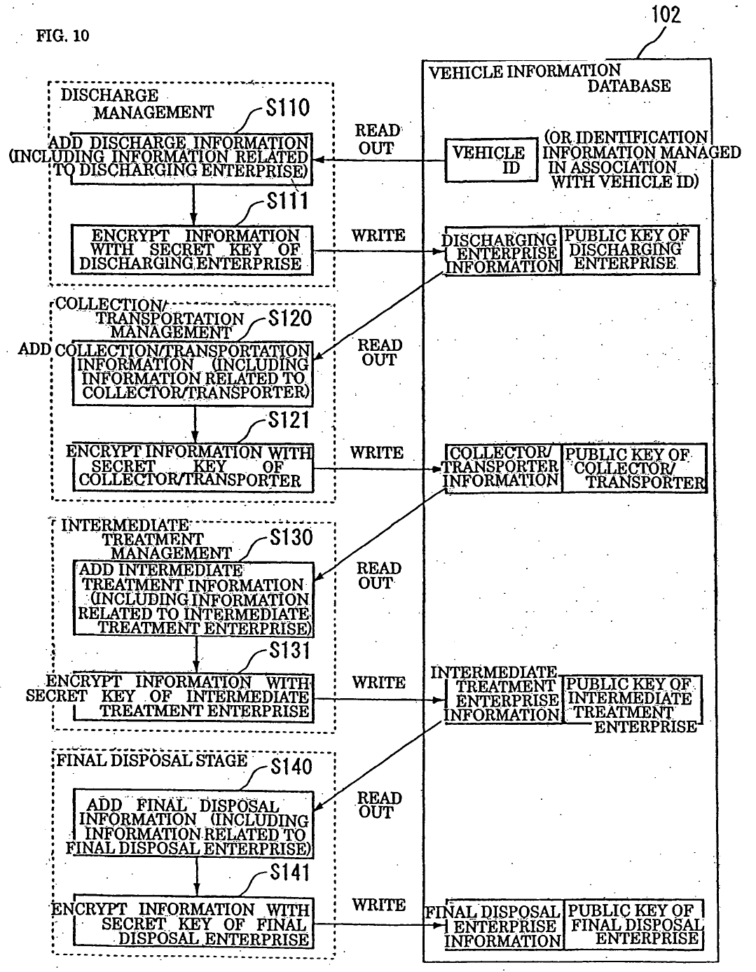

Next, the disposal/recycle system function will be described. FIG. 10 is a schematic diagram showing processing and a data flow in the disposal/recycle system function. In FIG. 10, discharge management, collection/transportation management, intermediate treatment management and final disposal management are functions included in the control unit 101. Note that as for the processing shown in FIG. 10, it is assumed that an electronic waste manifest has already been issued. Specifically, when the processing of the vehicle registration information deletion is performed, processing of waste manifest issuance is performed in conjunction therewith and a waste manifest as electronic data (waste manifest data) is recorded in the vehicle information database 102. A vehicle ID is included in this waste manifest data, and the waste manifest data and another data in the vehicle information database are associated with each other by use of this vehicle ID. Note that, instead of retaining the waste manifest data in the vehicle information database 102, the waste manifest data may be recorded and retained in another storage region in the vehicle information management server 10 or in a recording medium (not shown) such as a magnetic disk in another computer.

The above-described functions will be described below in order corresponding to the flow of FIG. 10. First, the discharge management function included in the control unit 101 reads out a vehicle ID of a vehicle as a target of disposal from the vehicle information database 102, and adds discharge information (including information related to the discharging enterprise) (Step S110). Thereafter, this vehicle ID and information including the discharge information are transmitted to the terminal 20 of the discharging enterprise through the communication network 80, and encrypting thereof is requested. This information is encrypted at the discharging enterprise side by use of a secret key of the discharging enterprise and returned to the discharge management function of the control unit 101. The discharge management function writes the returned information after encryption in the vehicle information database 102 as discharging enterprise information, and also writes a public key of the discharging enterprise in the vehicle information database 102 (Step S111).

Next, the collection/transportation management function included in the control unit 101 reads out the discharging enterprise information from the vehicle information database 102, and adds collection/transportation information (including information related to the collector/transporter) (Step S120). Thereafter, this information after the adding of information is transmitted to the terminal 20 of the collector/transporter through the communication network 80, and encrypting thereof is requested. This information is encrypted at the collector/transporter side by use of a secret key of the collector/transporter and returned to the collection/transportation management function of the control unit 101. The collection/transportation management function writes the returned information after encryption in the vehicle information database 102 as collector/transporter information, and also writes a public key of the collector/transporter in the vehicle information database 102 (Step S121).

Next, the intermediate treatment management function included in the control unit 101 reads out the collector/transporter information from the vehicle information database 102, and adds intermediate treatment information (including information related to the intermediate treatment enterprise) (Step S130). Thereafter, this information after the adding of information is transmitted to the terminal 20 of the intermediate treatment enterprise through the communication network 80, and encrypting thereof is requested. This information is encrypted at the intermediate treatment enterprise side by use of a secret key of the intermediate treatment enterprise and returned to the intermediate treatment management function of the control unit 101. The intermediate treatment management function writes the returned information after encryption in the vehicle information database 102 as intermediate treatment enterprise information, and also writes a public key of the intermediate treatment enterprise in the vehicle information database 102 (Step S131).

Next, the final disposal management function included in the control unit 101 reads out the intermediate treatment enterprise information from the vehicle information database 102, and adds final disposal information (including information related to the final disposal enterprise) (Step S140). Thereafter, this information after the adding of information is transmitted to the terminal 20 of the final disposal enterprise through the communication network 80, and encrypting thereof is requested. This information is encrypted at the final disposal enterprise side by use of a secret key of the final disposal enterprise and returned to the final disposal management function of the control unit 101. The final disposal management function writes the returned information after encryption in the vehicle information database 102 as final disposal enterprise information, and also writes a public key of the final disposal enterprise in the vehicle information database 102 (Step S141).

As described above, the processing from the Steps S110 to S141 is performed in accordance with the respective stages of the waste disposal, and information of wastes is managed. Thus, information related to the status of the waste disposal can be collectively managed. Moreover, this information is encrypted by use of the secret keys of the respective enterprises. Thus, by decrypting the information by use of corresponding public keys, the information can be surely ensured to be information added by the enterprises. In addition, information sufficient to accurately track the process of the waste disposal can be retained in the vehicle information database. Moreover, the information related to the waste disposal is associated with the vehicle ID of the vehicle of interest, and the vehicle ID corresponds to the vehicle ID written in the IC tag provided in the vehicle registration certificate or in the vehicle itself. Thus, it is possible to surely identify an individual vehicle which has become a target of waste disposal.

Note that, in the example of FIG. 10, it is assumed that the processing is performed in the order from the discharging enterprise to the collector/transporter to the intermediate treatment enterprise and to the final disposal enterprise. However, it is not necessary to always perform the processing in this order. It is sufficient that the information of the enterprises of the disposal/recycle system be added while being encrypted in stages. For example, a single enterprise may collectively perform both of the collection/transportation and the intermediate treatment, the intermediate treatment may be further divided into a plurality of stages by a plurality of enterprises, or the disposal enterprises may be divided according to materials included in wastes and the like.

The vehicle information management server 10, the terminals 20, the portable terminal 21, the vehicle sales website server 30 and the like, all of which are described above, include a computer system therein, respectively. Each of the processes of the processing of the vehicle information management described above is stored in a computer-readable recording medium in a form of a program. Accordingly, this program is read out and executed by a computer to perform the foregoing processing. Here, the computer-readable recording medium means a magnetic disk, a magneto-optical disk, a CD-ROM, a DVD-ROM, a semiconductor memory or the like. Moreover, this computer program may be delivered to the computer through a communication line, and a computer which has received this delivery may execute the program.

The embodiments of the present invention have been described above in detail with reference to the drawings. However, a specific configuration is not limited to the embodiments described above, but includes modifications and variations of the disclosed embodiments, and the like which do not depart from the spirit or essence of the present invention.

1. A vehicle management system for managing a plurality of vehicles, each vehicle comprising a vehicle body and a plurality of parts, the vehicle management system comprising:
a vehicle body identifier (ID) marked on the vehicle body, and integrated circuit (IC) tags attached to at least some of the plurality of parts, of each of the vehicles;
the IC tags storing the vehicle body ID and the respective part IDs of the plurality of parts;
storage means for also storing the vehicle body ID and the part IDs, the part IDs being associated with the vehicle body ID; and
identification means for identifying the vehicle by the vehicle body ID and the part IDs stored in the storage means, as well as by the vehicle body ID and a plurality of part IDs read out from the IC tags of the vehicle.

2. The vehicle management system according to claim 1, wherein the vehicle management system further comprises registration means for registering at least one of registration and history information of the vehicle.

3. The vehicle management system according to claim 1, wherein the IC tags storing the vehicle ID comprise storage means into which at least one of registration and history information of the vehicle can be written.

4. The vehicle management system according to claim 1, wherein one of the IC tags of each of the vehicles stores the vehicle ID and is attached to a meter of the vehicle, and the others of the IC tags of each vehicle comprise read-only storage means for storing only the respective part IDs.

5. The vehicle management system according to claim 1, wherein one IC tag of each of the vehicles comprises a data storage medium which includes a rewritable area, and wherein the others of the IC tags of each vehicle comprise a data storage medium which is read-only.

6. The vehicle management system according to claim 1, wherein the vehicle management system further comprises a registration certificate having an IC tag embedded thereon.

7. The vehicle management system according to claim 6, wherein the IC tag embedded on the registration certificate comprises a semiconductor having both rewritable storage and rewrite-inhibited storage.

8. The vehicle management system according to claim 6, wherein the IC tag embedded on the registration certificate comprises a semiconductor which stores at least the vehicle ID thereon.

9. A vehicle management system for managing each of a plurality of vehicles during a period of time between production and disposal of each of the vehicles, the vehicle management system comprising:
a vehicle information database;
a control unit;
at least one remote terminal comprising:
means for communicating with the control unit and said vehicle information database,
means for receiving data transmitted in a wireless manner from at least one radio frequency identification (RFID) tag attached to a vehicle, and
means for inputting data for storage within one of the vehicle information database and the RFID tag;
the control unit controlling data flow between the at least one remote terminal and the vehicle information database, and processing said data;
a vehicle body identifier (ID) secured on a vehicle body, and RFID tags attached to at least some parts of the plurality of parts, of each of the vehicles;
each RFID tag comprising at least the vehicle ID, and
the control unit identifying the vehicle based on information received from the plurality of RFID tags, and manages the information received based on the results of a comparison between the vehicle ID data received from the plurality of RFID tags and the vehicle ID secured on the vehicle body.

10. The vehicle management system of claim 9 wherein when the vehicle ID data received from the plurality of RFID tags agrees with the vehicle ID secured on the vehicle, the control unit permits at least one of registration information and history information of the vehicle to be written to the vehicle information database.

11. The vehicle management system of claim 9 wherein when the vehicle ID data received from the plurality of RFID tags does not agree with the vehicle ID secured on the vehicle body, the control unit extracts owner information from the vehicle information database and transmits the owner information to the at least one remote terminal.

12. The vehicle management system of claim 9, wherein each RFID tag comprise storage means into which at least one of registration and history information of the vehicle can be written.

13. The vehicle management system of claim 9, wherein
one RFID tag is attached to a meter of the vehicle, and
the remaining RFID tags used with the vehicle comprise read-only storage means for storing only the respective part IDs.

14. The vehicle management system of claim 9, wherein one of the RFID tags for each of the vehicles comprises a data storage medium which includes a rewritable area, and wherein the other IC tags for each said vehicle comprise a data storage medium which is read-only.

15. The vehicle management system of claim 9 wherein the data flowing between the at least one remote terminal and the vehicle information database is encrypted.

16. The vehicle management system according to claim 9, wherein the vehicle management system further comprises a registration certificate having an IC tag embedded thereon.

17. The vehicle management system according to claim 16, wherein the IC tag embedded on the registration certificate comprises a semiconductor having both rewritable storage and rewrite-inhibited storage.

18. The vehicle management system according to claim 16, wherein the IC tag embedded on the registration certificate comprises a semiconductor which stores at least the vehicle ID thereon.
